(19) United States
(12) Patent Application Publication
(10) Pub. No.: US 2014/0219051 A1
(43) Pub. Date: Aug. 7, 2014

(54) CONFIGURABLE ACQUISITION UNIT

(71) Applicant: INOVA LTD., George Town (KY)

(72) Inventor: Dennis Ray Pavel, Prosper, TX (US)

(73) Assignee: INOVA LTD., George Town (KY)

(21) Appl. No.: 14/172,613

(22) Filed: Feb. 4, 2014

Related U.S. Application Data
(60) Provisional application No. 61/760,425, filed on Feb. 4, 2013.

(51) Int. Cl. G01V 1/00; G01V 1/22; G01V 1/38; G01V 1/16

(52) U.S. Cl. CPC G01V 1/00; G01V 1/16; G01V 1/22; G01V 1/38
USPC 367/15; 367/14

(57) ABSTRACT

Embodiments of a configurable acquisition unit are disclosed together with applications for configurable acquisition units. In one embodiment, an acquisition unit includes a seismic data collection module that with a first housing. The acquisition unit also includes a second module with a second housing. The first housing is releasably coupled to the second housing, and when the first housing is coupled to the second housing, an outer surface of the first housing abuts an outer surface of the second housing.

### CROSS REFERENCE TO RELATED APPLICATIONS

This application claims priority to and the benefit of U.S. Provisional application No. 61/760,425, entitled “CONFIGURABLE ACQUISITION UNIT,” and which was filed on Feb. 4, 2013.

### TECHNICAL FIELD

The technical field generally relates to seismic exploration, and more particularly to configurable acquisition units for use in seismic exploration.

### BACKGROUND

Several different kinds of acquisition units are used in seismic exploration, including cabled acquisition units, wireless acquisition units, and autonomous node acquisition units. Cabled acquisition units can provide real-time or near real-time quality control (QC) data, status information, and even actual seismic data over one or more wires that couple the cabled unit to one or more central stations. Wireless acquisition units can provide real-time or near real-time QC data and status information to a central station via a radio link, but typically cannot provide much, if any, seismic data over the radio link due to the amount of the seismic data and the limited bandwidth and range of the radio link. Wireless systems may send the data back to a central location, typically through an infrastructure of intermediate radio repeater towers and/or high speed cable backbones. Wireless acquisition units can also be deployed in a variety of topographies where cabled acquisition would be difficult or impossible. Autonomous node seismic acquisition units may operate autonomously with high productivity, but may not be in communication with a central station during operation. Instead, data may be harvested from autonomous node acquisition units after acquisition is complete by retrieving the autonomous node (or a portion thereof), or by passing a harvesting unit nearby.

While the detailed structure of an acquisition unit typically depends at least in part on the kind of acquisition geometry desired (e.g., cabled, wireless, autonomous node), prior art acquisition units can generally be divided into those with interconnecting cables and all-in-one acquisition units. For example, the Hawk™ and FireFly® products available from INOVA Geophysical each include a field station unit with connectors for an external battery and an external sensor. An external battery can be coupled to the field station unit through one or more cables connecting to the power connector on the field station unit. Similarly, an external sensor can be coupled to the field station unit through one or more cables connecting to the sensor connector on the field station unit. The cabled connection between the sensor and battery to the field station unit provides flexibility in that different sizes and types of batteries as well as different types of sensors can be used. However, the interconnecting cables between the components in this arrangement of an acquisition unit can be less desirable in certain applications, such as those requiring the complete station to be buried to minimize theft or tampering.

Another type of acquisition unit that does not include any interconnecting cables is generally known as an all-in-one, or a self-contained acquisition unit. These acquisition units solve some of the difficulties mentioned above (e.g., they are relatively easy to bury, they don't suffer from cables damaged by animals, etc.), but have their own drawbacks. For example, it is typically much harder to replace or change out components in an all-in-one acquisition unit, so that if, for example, a new type of sensor, or a new, fresh battery is to be used, the all-in-one acquisition unit may need to be completely disassembled, thus exposing the internal components to a potentially hazardous environment if the unit is disassembled in the field. The all-in-one acquisition units thus may provide less flexibility as compared with the acquisition units with interconnecting cables.

### SUMMARY

In one example of an acquisition unit described herein, a seismic data collection module may include a first housing. A second module of the acquisition unit may include a second housing, and the first housing may be releasably coupled to the second housing. When the first housing is coupled to the second housing, an outer surface of the first housing may abut an outer surface of the second housing.

In some embodiments, the first housing may include a first connector and the second housing may include a second connector, and one of the first or second connectors may releasably receive the other of the first or second connectors. The first connector may releasably receive at least one protrusion from the second connector, and the second connector may releasably receive at least one protrusion from the first connector. The outer surface of the first housing may abut the outer surface of the second housing around an entire perimeter of one or both of the first and second connectors.

In some embodiments, a recess defined in one of the first or second housings may releasably receive a protrusion from the other of the first or second housings. A connector of the first housing may interchangeably receive a complementary connector of any of a plurality of different types of modules in addition to the second module. The first and second housings may be releasably coupled together in a vertical stack. The first housing may define the first module, the second housing may define the second module, and the second housing may be separate and distinct from the first housing. The seismic data collection module and the second module may be electrically and mechanically coupled together through at least one connector. The seismic data collection module may include a processing unit, a storage device, and an analog to digital converter.

In some embodiments, the second module may include a sensor module. The sensor module may include at least one of an analog or digital motion sensor disposed therein. The sensor module may include three motion sensors, and the seismic data collection module may be configured to receive three channels of seismic data corresponding to the three motion sensors. The sensor module may further include a pressure sensor. The sensor module may include a terminal for connection to an external sensor.

In some embodiments, the second module may include a power supply module. The power supply module may include a battery disposed in the second housing. The power supply module may include a terminal for connection to an external power source. The second module may also or alternatively include a telemetry module. The telemetry module may be one of a wireless communications unit, a wired communications unit, or an autonomous node communications unit.

In some embodiments, the seismic data collection module may include a telemetry unit, and the second module includes a sensor module. The first and second housings may be generally cylindrical. A first connector may be integral with the first housing. A first connector may be securely attached to the first housing and may be made from a different material than the first housing. A first connector attached to or defined by the first housing may include a biasing member adapted to release the second housing from the first housing only on the application of a release force. A seal may be configured to prevent contamination of the acquisition unit through at least the first connector between the first and second housings. The acquisition unit may further include an electrical bus between the seismic data collection module and second module, with the electrical bus including a power line and at least one data line common to the seismic data collection module and second module. The acquisition unit may further include a third module including a third housing, the third housing may be releasably coupled to one of the first or second housings with an outer surface of the third housing abutting one of the outer surfaces of the first housing or the second housing. The outer surface of the first housing may be substantially coextensive with the outer surface of the second housing when the second module is coupled together with the seismic data collection module.

In another example described herein, a seismic acquisition unit may include a first housing at least partially enclosing a data storage, a second housing at least partially enclosing a seismic sensor, and a third housing at least partially enclosing one of a power supply unit or a telemetry unit. Each of the first, second, and third housings may include a coupling connector configured to releasably couple the respective housing to one of the other of the first, second, or third housings.

In some embodiments, the coupling connector of each of the first, second, and third housings may be configured to releasably couple the respective housing to one of the other of the first, second, and third housings in an abutting relationship. The coupling connector of the first housing may be a first coupling connector that releasably couples the first housing to the second housing, and the first housing may further include a second coupling connector configured to releasably couple the first housing to the third housing. Each of the first, second, and third housings may have substantially the same diameter. The first, second and third housings may each define a disk shape. The first, second, and third housings, when coupled together, may define a common axis. At least one of the first, second, and third housings may completely enclose the respective data storage, sensor, or power supply unit and provides a seal therearound. A fourth housing may at least partially enclose a fourth module, with the fourth housing also including a connector configured to releasably couple with one of the first, second, or third housings. Each of the first and second housings may define a generally cylindrical shape and have a substantially similar diameter, and each of the third and fourth housings may define a generally half-cylindrical shape and have a substantially similar size, and the third and fourth housings may together define a generally cylindrical shape with a diameter substantially similar to that of the first and second third housings. An outer skin may be configured to enclose at least the first, second, and third housings and provide a seal therearound.

In another example of a seismic data collection apparatus described herein, a seismic data collection module may include a first housing, and the first housing may include a connector adapted to interchangeably couple the seismic data collection module to a plurality of varying types of modules such that an outer surface of the respective varying types of modules abuts an outer surface of the first housing.

In some embodiments, the plurality of varying types of modules may include two or more modules selected from a group including a sensor module, a power supply module, or a telemetry module. The connector may interchangeably secure the seismic data collection module to one of the plurality of varying types of modules such that a positive force is needed to release the seismic data collection module from the one of the plurality of varying types of modules. The connector may rotatably secure the seismic data collection module to the one of the plurality of varying types of modules.

In another example described herein, a mixed-mode seismic surveying system may include a first plurality of acquisition units configured for a first topography, and a second plurality of acquisition units configured for a second topography. Each of the acquisition units in the first and second pluralities of acquisition units may include a substantially similar data collection module defined by a first housing and configured to be releasably coupled to and uncoupled from at least one other module via a first connector of the first housing.

In some embodiments, the first connector of the first housing for each of the respective data collection modules may cause an outer surface of the first housing to abut an outer surface of a second housing of the at least one other module when the data collection module is coupled to the at least one other module. The first topography may be a transition zone, and each of the first plurality of acquisition units may include a buoy for floatation. The second topography may be a land zone proximate the transition zone, and each of the second plurality of acquisition units may include a sensor module adapted to be buried in the subsurface.

In some embodiments, the first topography may be adapted for cable-based seismic acquisition and the second topography may not be adapted for cable-based seismic acquisition. Each of the first plurality of acquisition units may include a cabled telemetry unit configured to receive a cable coupled to and in communication with a central station, and each of the second plurality of acquisition units may include a wireless telemetry unit configured to wirelessly communicate with the central station. One of the first or second topographies may be under water. Each of the first and second plurality of acquisition units may have a positioning system, and the positioning system may be at least partially enclosed in a telemetry module housing, the telemetry module housing being releasably coupled to the data collection module. Each of the first and second plurality of acquisition units may include a telemetry module configured to communicate with a central station and transmit status information and quality control information to the central station.

### BRIEF DESCRIPTION OF THE DRAWINGS

FIG. 1 is a simplified block diagram of an embodiment of a configurable acquisition unit.

FIGS. 2A, 2B, 2C, and 2D are simplified block diagrams of embodiments of a sensor module for use in the configurable acquisition unit of FIG. 1.

FIG. 3 is a simplified block diagram of an embodiment of a configurable acquisition unit.

FIGS. 4A, 4B, 4C, and 4D are simplified block diagrams of embodiments of a power supply module for use in the configurable acquisition unit of FIG. 3.

FIG. 5 is a simplified block diagram of an embodiment of a configurable acquisition unit.

FIGS. 6A, 6B, and 6C are simplified block diagrams of embodiments of a telemetry module for use in the configurable acquisition unit of FIG. 5.

FIGS. 7A and 7B are simplified block diagrams of alternate embodiments of a configurable acquisition unit.

FIG. 8 is a simplified block diagram of an embodiment of a configurable acquisition unit.

FIG. 9 is a simplified block diagram of an embodiment of a configurable acquisition unit.

FIGS. 10A, 10B, 10C, 10D, 10E, and 10F are perspective views of various embodiments of configurable acquisition units.

FIGS. 11A through 11H are simplified cross-section views of various embodiments of a connector for use between housings of a configurable acquisition unit.

FIGS. 12A and 12B are illustrations of a mixed-mode implementation using configurable acquisition units.

FIG. 13 is an illustration of another mixed-mode implementation using configurable acquisition units.

### DETAILED DESCRIPTION

Described herein are embodiments of configurable data acquisition units, such as seismic data acquisition units. The configurable acquisition units may include a plurality of modules, each module including a housing and being at least partially defined thereby. The modules may be releasably coupled to one another through their respective housings, and the modules may be interchangeable in that a variety of different modules and/or a variety of different types of modules may be coupled to any given module.

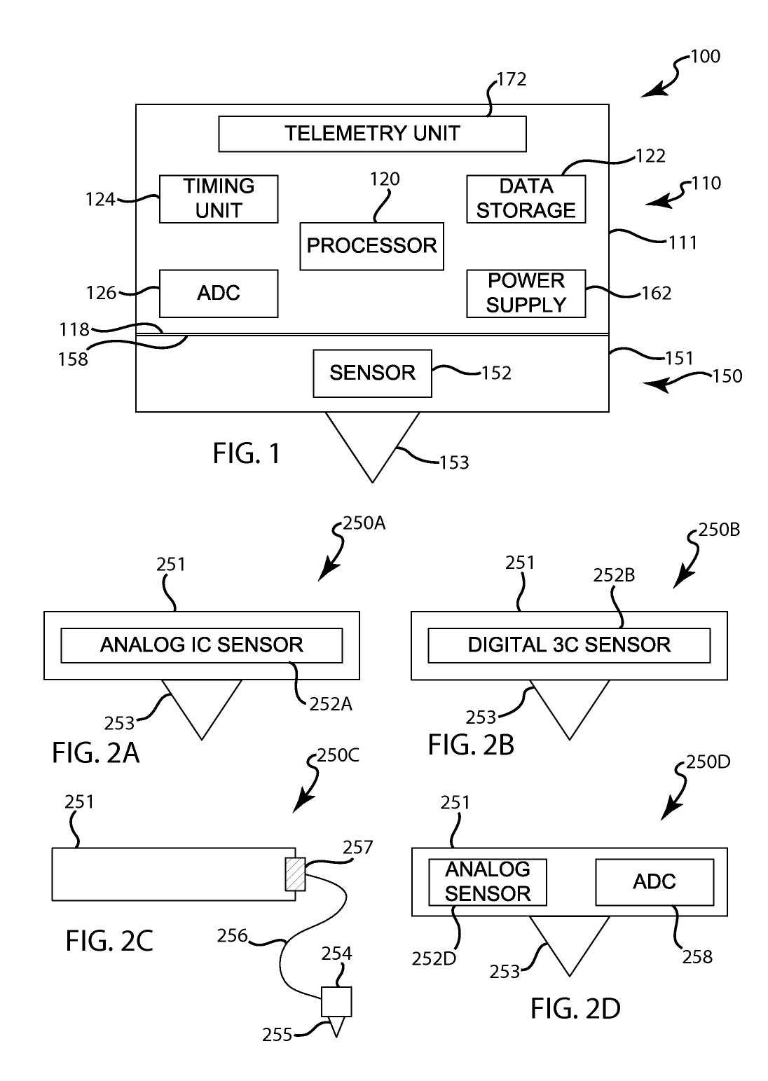

With reference to FIG. 1, a configurable data acquisition unit 100 includes a plurality of modules 110, 150. The data acquisition unit 100 may be suitable for cabled, wireless, and/or autonomous node applications, and may further be suitable for being entirely buried, partially buried, positioned on top of the earth surface, positioned under water, and/or positioned on top of water.

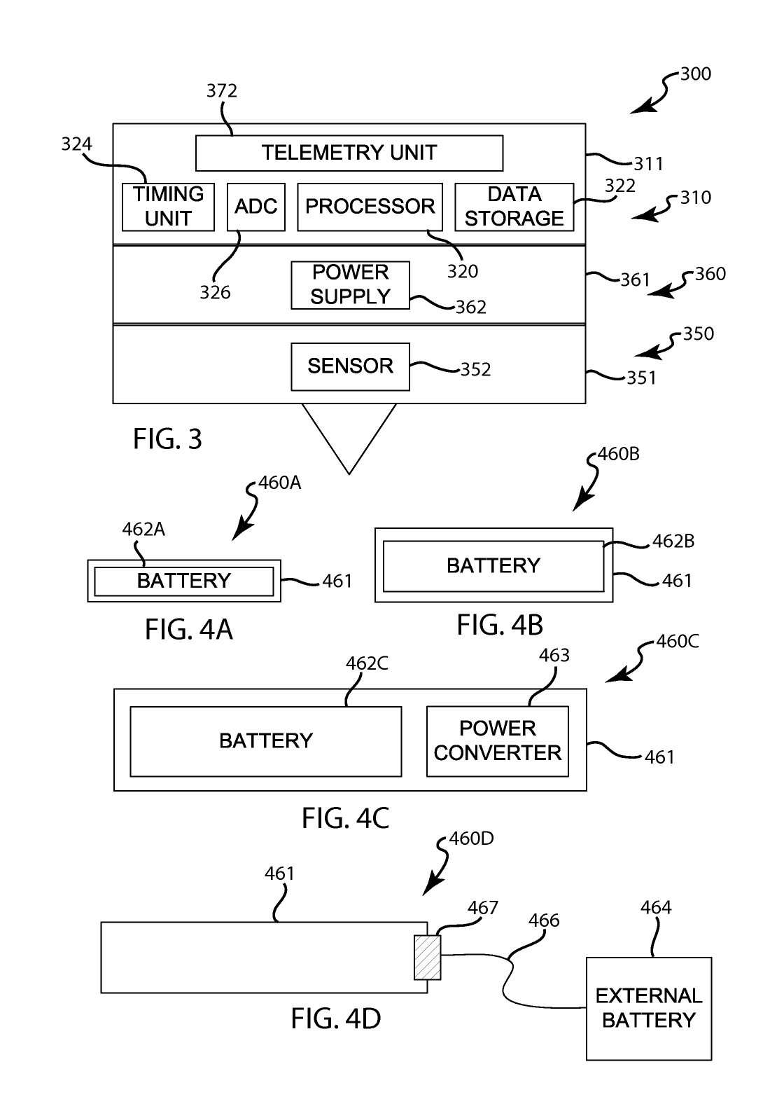

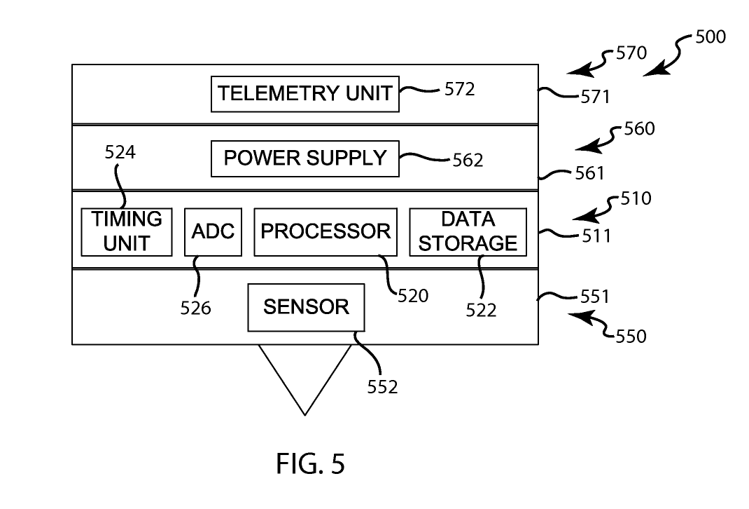

The data acquisition unit 100 may include a first module 110, which may be a data collection module 110. The data acquisition unit 100 may also include a second module 150, which may be a sensor module 150. In some examples, with later reference to FIGS. 3 and 5, the data acquisition unit 100 may include more than two modules—for example, the data acquisition unit 100 may include 2, 3, 4, 5, 6, or more than 6 different modules in some embodiments. Each of the modules may include components for one or more functions for the acquisition unit, such as data storage, power supply, sensing, processing, timing, communication, and so forth, some examples of which are described below. In some examples, there is a one-to-one relationship between functions and modules; in other examples, a single module may perform several functions, or multiple modules may perform a single function.

Each module 110, 150 may include a respective housing 111,151, which may define at least in part the different, respective modules 110, 150. For example, the data collection module 110 may include a first housing 111, which may define at least in part the data collection module 110. In other words, the first housing 111 may at least partially enclose (and, in some embodiments, may fully enclose), one or more internal components of the data collection module 110. Similarly, the sensor module 150 may include a second housing 151, which may define at least in part the sensor module 150 and/or may at least partially enclose one or more internal components of the sensor module 150. In some examples, the respective housings 111, 151 may completely enclose the respective modules 110, 150 and may even provide a seal therearound (e.g., a water seal, a dirt seal, etc.). In other examples, one or more of the housings 111, 151 may only partially enclose components of a module such that another housing or lid may need to be coupled to the housing in order to form a seal protecting the interior components.

The first and second housings 111, 151 (and therefore the first and second modules 110, 150) may be releasably coupled together such that an outer surface 118 of the first housing 111 abuts an outer surface 158 of the second housing when the first housing 111 is coupled to the second housing 151. In some examples, the outer surface 118 of the first housing 111 may be substantially coextensive with the outer surface 158 of the second housing 151 and/or the first housing 111 and the second housing 151 may be coupled together around an entire perimeter of a connector (not shown in FIG. 1) or around the entire perimeter of one or both housings 111, 151 when the two modules 110, 150 are coupled together. Also, in some embodiments, one or both of the first and second housings 111, 151 may be stepped, such that a recess defined in one housing receives a protrusion defined by the other housing, or vice versa. When the data collection module 111 and the sensor module 150 are not coupled together, the first and second housings 111, 151 may be separate and distinct from one another.

The data collection module 110 may include one or more of a processor 120, a data storage 122, a timing unit 124, an analog to digital converter (ADC) 126, a power supply 162, and a telemetry unit 172, and thus may perform functions associated with each of these components 120, 122, 124, 126, 162, 172. The data collection module 110 may also include a GPS or other positioning system (which may be included in one or both of the timing unit 124 or the telemetry unit 172), a sensor interface (not shown in FIG. 1), a power converter (not shown in FIG. 1), and so forth. In general, the data collection module 110 may contain any one or more components, depending on the desired or intended use of the data acquisition unit 100. For example, if the data acquisition unit 100 is desired to be used in a cabled seismic acquisition, the telemetry unit 172 may include one or more connectors and/or adapters through which the data acquisition unit 100 can be coupled via one or more cables to a central station. As another example, if the data acquisition unit 100 is desired to be used in a wireless seismic acquisition, the telemetry unit 172 may include one or more antenna or other radio communication devices through which the data acquisition unit 100 can be wirelessly coupled to a central station. Other examples of potential applications for the acquisition unit 100 are described below with reference to FIGS. 2A through 6C.

The components 120, 122, 124, 126, 162, 172 of the data collection module 110 may be rigidly attached to the interior of the first housing 111 in some examples, or may be otherwise coupled to the first housing 111 in other examples. In general the components 120, 122, 124, 126, 162, 172 may be coupled to the first housing 111 in any suitable manner, and thus the details of how the components are coupled to the first housing 111 are not specified in FIG. 1. Furthermore, for clarity, the electrical interconnects between the components 120, 122, 124, 126, 162, 172 are not shown in the simplified block diagram of FIG. 1.

Still referring to FIG. 1, the sensor module 150 may include a seismic sensor 152 at least partially enclosed in the second housing 151. A spike 153 may be removably coupled to the second housing 151 in some examples in order to increase coupling with the ground when the data acquisition unit 100 is installed in the field. The spike 153 may, for example, screw on and off of the housing 151 of the sensor module 150.

With reference to FIG. 1, the first and second housings 111, 151 may be coupled together in a vertical stack such that the first and second housings 111, 151 define and share a common vertical axis, whereas in other embodiments the first and second housings 111, 151 may be coupled together in a horizontal stack, or in any other suitable manner.

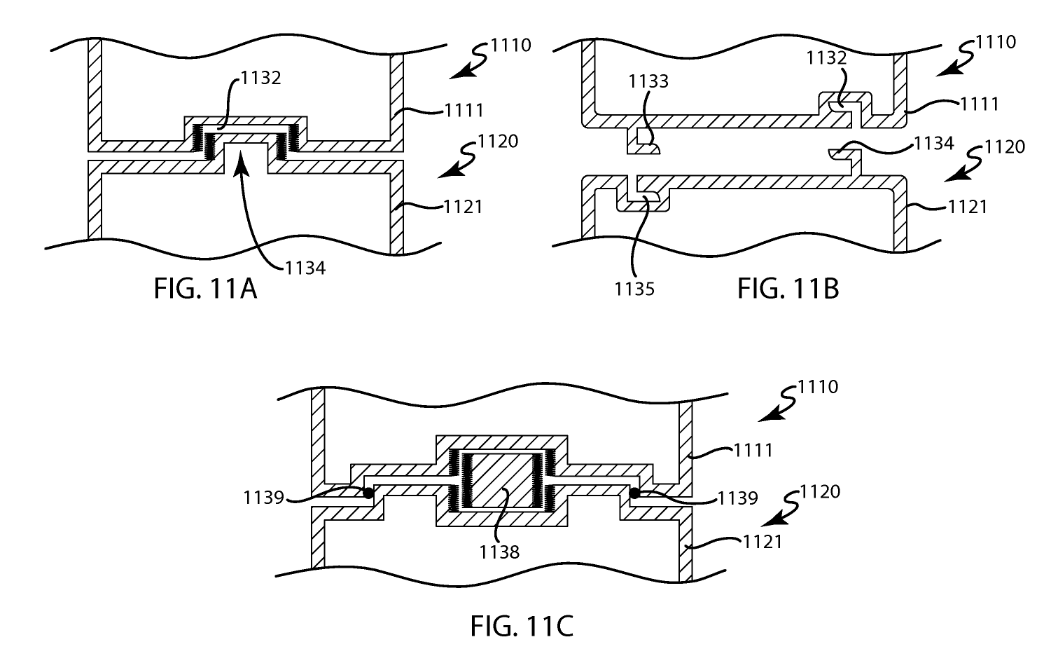

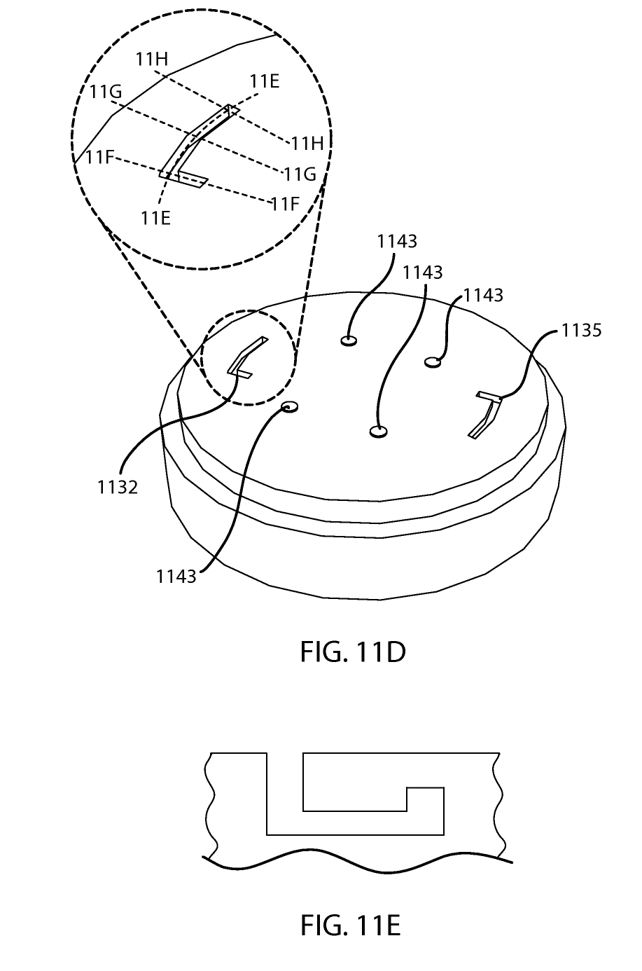

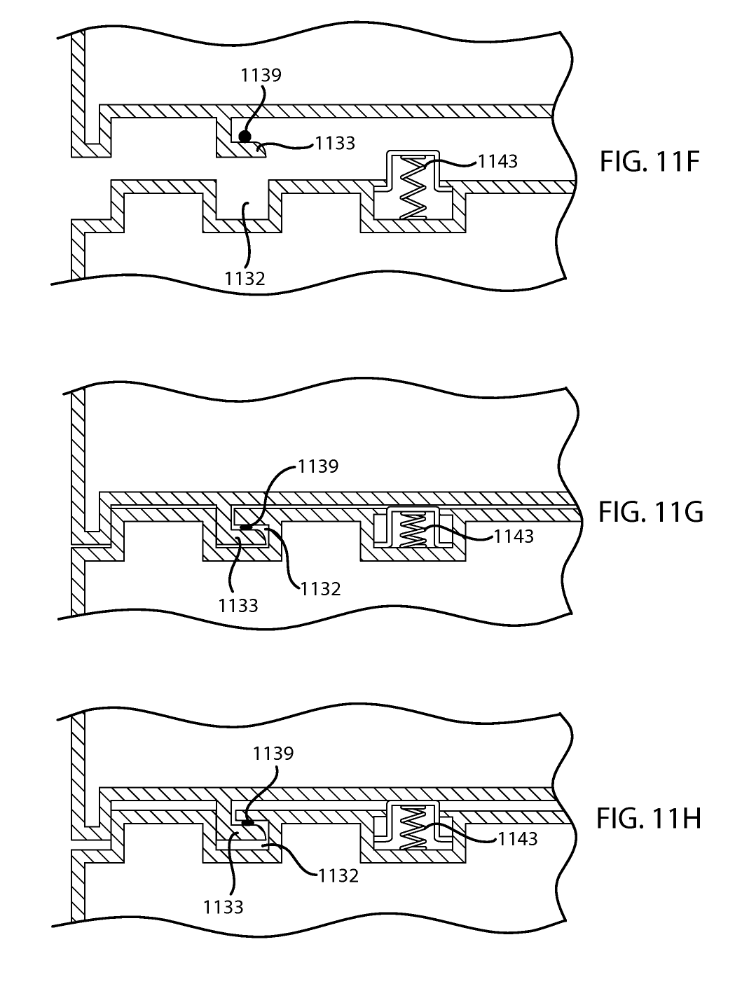

In some embodiments, one or both of the first and second housings 111, 151 may include and/or define a connector (not shown in FIG. 1, but several examples are shown in FIG. 11 and described in more detail below). For example, one of the first or second housings 111, 151 may include and/or define a male-type connector, and the other of the first or second housings 111, 151 may include and/or define a female-type connector. In other examples, a hybrid or hermaphrodite-type connector may be used to releasably couple the first and second housings 111, 151 together. Each of the modules 110, 150 may interchangeably couple to any of a plurality of different modules of one type and/or to a plurality of different types of modules through one or more connectors (as described below with reference to FIGS. 11A through 11C). For example, the housing 111 of the data collection module 110 may (for example, through one or more connectors) interchangeably receive any of a plurality of different sensor modules 150, as described below with reference to FIG. 2. In other examples, the first module 110 may be interchangeably coupled to a plurality of varying types of modules (e.g., not just different sensor modules, but to a sensor module, a power supply module, etc.). Regardless of the kind or type of module releasably coupled to the first module 110, at least a portion of at least one outer surface 118 of the first module 110 and an outer surface of the other module may abut in some embodiments. As described in more detail below, the first and second modules 110, 150 may be interchangeably secured together in some examples, and may be secured via any of a variety of different mechanisms, including those in which a positive force is needed to release one module 150 from the other module 110.

Taking now FIGS. 2A through 2B as two examples of a sensor module 150, various different sensor modules 250A, 250B may alternatingly be releasably coupled to a data collection module (e.g., 110 in FIG. 1). For example, a first sensor module 250A may be defined by a housing 251, and may include an analog 1C sensor (e.g., an analog geophone) 252A, and a detachable spike 253. The analog 1C sensor may be a geophone that measures one component (e.g., vertical) of motion during a seismic survey. With respect to FIG. 2B, a second sensor module 250B may be similar to the first sensor module 250A, except that the second sensor module 250B includes a digital 3C sensor 252B. The digital 3C sensor 252B may include three micro-electro-mechanical (MEMS) accelerometers configured to measure three orthogonal components of motion (e.g., in the x, y, and z directions), and the data collection module 110 may be configured to receive three channels of seismic data corresponding to the three orthogonal components of motion detected.

Each of the first and second sensor modules 250A, 250B illustrated in FIGS. 2A and 2B may be used as the sensor module 150 in FIG. 1 and may thus be interchangeably coupled to the data collection module 110. In operation, for example, the first sensor module 250A shown in FIG. 2A may be releasably coupled to the data collection module 110 during a first seismic survey where only one component of seismic data is needed. If three components of seismic data are desired, the first sensor module 250A may be removed from the data collection module 110, and the second sensor module 250B may be coupled to the data collection module 110. Then, if a subsequent survey again only requires one component, the second sensor 250B may be removed and the first sensor 250A reinstalled. In this manner, the data acquisition unit 100 in FIG. 1 is configurable and can be customized based on the needs of a seismic survey and/or on the equipment available, and modules such as the sensor modules 250A, 250B can be coupled to the data collection module 110, decoupled therefrom, coupled to the module 110 again, and so forth, as many time as needed.

In some examples, each sensor module 250A, 250B may be used with any data collection module 110, and vice versa. In this manner, when any given sensor module 250A, 250B (or, similarly, when any given data collection module 110) malfunctions or is destroyed, it can be switched out for another. Also, when new equipment is needed or available, it may be less expensive to replace one or more modules than in an all-in-one type of acquisition unit, while still retaining the flexibility offered by acquisition units with interconnecting cables. Similarly, the configurable nature of the acquisition unit 100 allows for incremental improvements to be efficiently deployed—for example, if a new type of sensor comes out, only new sensor modules 150 need to be ordered and installed, while the previous data collection modules 110 can still be used. Also, providing a common data collection module 110 (or another type of module) may be useful should data acquired using different types of sensors need to be merged as the data may be more uniform and less prone to calibration errors.

Referring to FIGS. 2A and 2B, although two examples of sensors 252A, 252B were given as being an analog 1C sensor 252A and a digital 3C sensor 252B, other types of sensors may similarly be employed. For example, an analog 3C sensor or a digital 1C sensor. Similarly, for marine applications, a hydrophone sensor may be used in place of, or in addition to, a motion sensor such as a geophone or accelerometer. In some examples, a single sensor 152, 252A, 252B may be included in a sensor module 150, 250, whereas in other embodiments, a mini-array of sensors may be included in the one or more sensor modules 150, 250.

Referring now to FIG. 2C, in some examples, a sensor module 250C may include a terminal 257 for connection to an external sensor 254 through an interconnecting cable 256. The external sensor 254 may allow for better coupling with the ground through a removable spike 255, for example, and therefore it may be desirable in some instances to use a sensor 254 external to the sensor module 250C, while still maintaining the use of a common data collection module 110. In other words, although using an external sensor 254 may require using an interconnecting cable 256, it may still provide flexibility to use the data collection module 150 in some embodiments.

Referring now to FIG. 2D, in some embodiments, an analog to digital converter (ADC) 258 may be included within the sensor module 250D, proximate an analog sensor 252D, in order to reduce noise and other interference factors that may otherwise reduce the signal to noise ratio of the seismic signal as it is transmitted to the data collection module 110.

With reference now to FIG. 3, another example of a configurable acquisition unit 300 is shown. The acquisition unit 300 illustrated in FIG. 3 is similar to the acquisition unit 100 illustrated in FIG. 1, except that the power supply 362 is separately housed within a third housing 361 that defines at least in part a third, power supply module 360. Whereas the interchangeable sensor modules 250A, 250B, 250C, 250D illustrated in FIGS. 2A through 2D provide flexibility in the use of different sensors, separating the power supply 362 from the data collection module 310 may allow flexibility in using various different power supplies. For example, FIG. 4A illustrates a first power supply module 460A with a relatively low capacity battery 462A disposed within a housing 461. FIG. 4B, in contrast, shows a power supply module 460B with a much higher capacity battery 462B than the battery 462A shown in FIG. 4A. Alternatively, the batteries 462A, 462B may be different types of batteries (e.g., lithium ion, lead acid, etc.). In still other embodiments, it may be desirable to quickly change out a dead battery with a fresh one, and the separate power supply module 360 may facilitate this change.

In some embodiments, and with reference to FIG. 4C, a power supply module 460C may include a power converter 463 within the housing 461, which may for example convert AC to DC power, downconvert DC power from one voltage level to another, and so forth. In other examples, however, no power converter may be needed, or a power converter may be included in the data collection module 110, 310.

In still other embodiments, and with reference to FIG. 4D, a power supply module 460D may alternatively (or additionally) include a terminal 467 for connection to an external power source (such as an external battery 464 or a power line from an intermediary or central station) through an interconnecting cable 466. With reference to FIGS. 2C and 4D, in some examples, separate terminals may be used for connecting an external sensor 254 and an external power source 464, whereas in other embodiments (not shown), a single terminal may be used to connect both an external sensor 254 and an external power source 464.

Referring to FIGS. 4A through 4D, in some embodiments, the power supply module 460A, 460B, 460C, 460D may include a data storage that can be removable from the acquisition unit together with the battery 462A, 462B, 462C, 464. By including a data storage in the power supply module 460A, 460B, 460C, 460D, seismic data may be transferred to a central station at the same time as recharging the battery, while reducing the number of modules needed to be serviced in the acquisition unit.

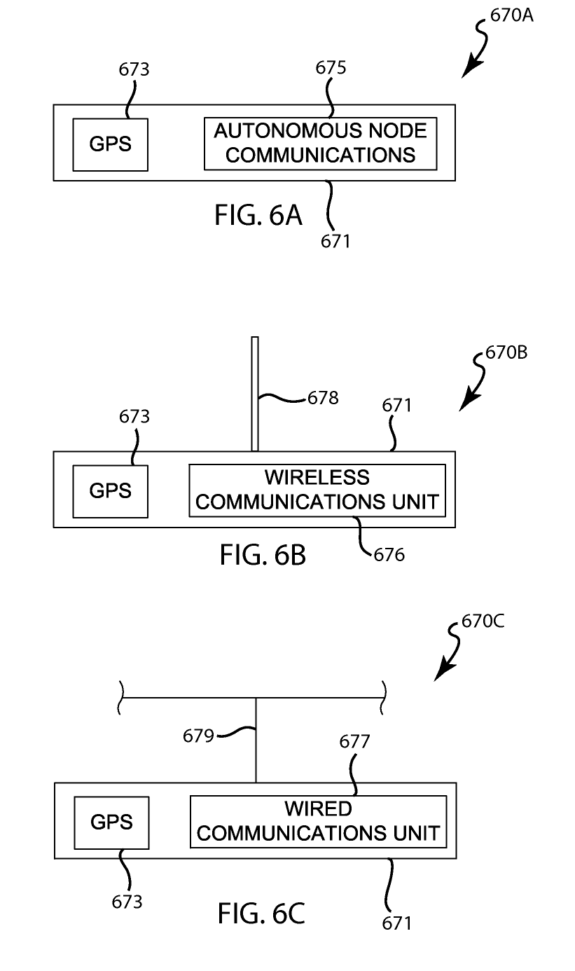

With reference now to FIG. 5, another example of a configurable acquisition unit 500 is shown. The acquisition unit 500 illustrated in FIG. 5 is similar to the acquisition units 100, 300 illustrated in FIGS. 1 and 3, except that the telemetry unit 572 is housed within a fourth housing 571 that defines at least in part a fourth, telemetry module 570. Similar to the interchangeable sensor modules 250A, 250B, 250C, 250D illustrated in FIGS. 2A through 2D and the interchangeable power supply modules 460A, 460B, 460C, 460D illustrated in FIGS. 4A through 4D, a plurality of different telemetry units 670A, 670B, 670C illustrated in FIGS. 6A through 6C may be interchangeably coupled to the data collection module 510 illustrated in FIG. 5, thereby allowing flexibility in using different telemetry units in the acquisition unit 500. For example, FIG. 6A illustrates a first telemetry module 670A with an autonomous node communications unit 675 and a Global Positioning (GPS) unit 673 disposed within a housing 671. The autonomous node communications unit 675 may, for example, include a short range wireless antenna (e.g., WiFi, Bluetooth, etc.) configured to interact with a harvester unit that passes nearby.

FIG. 6B illustrates a second telemetry module 670B with a wireless communications unit 676 and a GPS unit 673 disposed within a housing 671, and also includes an antenna 678 coupled to the housing 671. The wireless communications unit 676 may, for example, include a VHF radio, or other mid to long range wireless radio that can be communicatively coupled with a central station.

FIG. 6C illustrates a third telemetry module 670C with a wired or cabled communications unit 677 and a GPS unit 673 disposed within a housing 671, and also includes a cable 679 extending from the first housing 671. The cable 679 may extend to a central station, as described above, and may be an optical cable, an electrical cable, and so forth. The wired communications unit 677 may be a transmitter and/or receiver adapted to transmit and/or receive signals on the cable 679.

With reference to FIGS. 6B and 6C, in some embodiments, the wireless communications unit 676 or the wired/cabled communications unit 677 may include circuitry that allows the wireless communications unit 676 or the wired/cabled communications unit 677 to operate in an autonomous mode if needed. The circuitry may include, for example, a positioning system (which, in the case of GPS, also includes timing control). For example, with reference to FIG. 6B, if wireless communication with the central station is interrupted, the wireless communication unit 676 may be configured to switch to an autonomous mode of operation (similar to how the autonomous node communications unit 675 in FIG. 6A would operate) until wireless communication with the central station is restored. Similarly, with reference to FIG. 6C, if the cable 679 is cut or the wired communication with the central is otherwise interrupted, the wired/cabled communications unit 677 may be configured to switch to an autonomous mode of operation until the wired/cabled communication is restored. During autonomous operation of the wireless communications unit 676 or the wired/cabled communications unit 677, the units may record seismic data and operate independently of control or other signals that may otherwise be received from the central station. The units may do so based on, for example, timing information generating by an internal clock that may be included in positing system circuitry, such as GPS.

In operation, any of the telemetry modules 670A, 670B, 670C may be used as the telemetry module 570 in FIG. 5 and may be releasably coupled to the data collection module 510, either indirectly or directly. In FIG. 5, for example, the telemetry module 570 is indirectly coupled to the data collection module 510 through a power supply module 560. In any event, depending on the desired mode of acquisition, any of the telemetry modules 670A, 670B, 670C may be interchangeably used in the data acquisition unit 500 illustrated in FIG. 5. For example, the first telemetry module 670A illustrated in FIG. 6A may be used in the acquisition unit 500 when an autonomous node seismic survey is to be undertaken. Subsequently, the second or third telemetry modules 670B, 670C may be used in the acquisition unit 500 when a wireless or cabled seismic survey is to be undertaken. In other words, the acquisition unit 500 may be configurable for use in any one of an autonomous node application, a wireless application, or a wired application, depending on which of the telemetry modules 670A, 670B, 670C illustrated in FIGS. 6A through 6C is used as the telemetry module 570.

Each of the telemetry modules 670A, 670B, 670C is illustrated as including a GPS unit 673. The GPS unit 673, when used, may provide position and/or timing information to the acquisition unit. In some examples, however, no GPS unit may be included in the telemetry module or anywhere in the acquisition unit 500. In still other examples, a GPS unit may be included in a different module (e.g., the data collection module 510 in FIG. 5, or the power supply module 562 in FIG. 5), or a different type of positioning system (e.g., GLONASS) may be used. Referring to FIG. 6C, even in a cabled telemetry acquisition unit, a GPS unit 673 may be included and provide timing information in order to, for example, relax constraints on the cable connecting the acquisition unit 500 to the central station—for example, if a GPS unit 673 provides timing information to a cabled acquisition unit, the cables may not need to carry synchronous signals to the central station, thereby allowing lower quality and cheaper cables to be used.

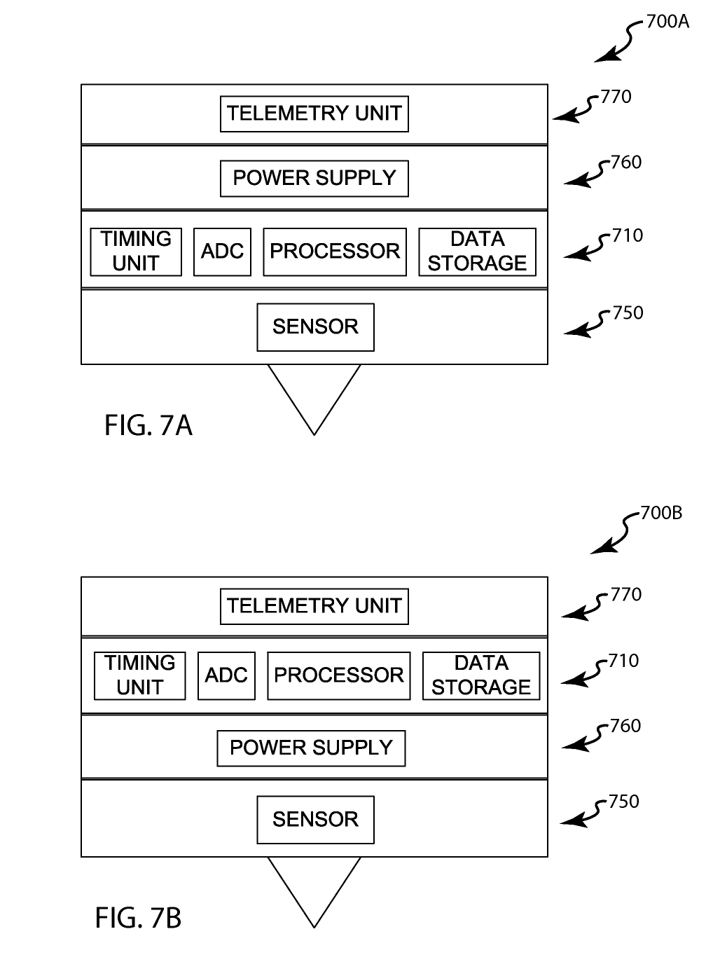

FIGS. 7A and 7B illustrate additional embodiments of configurable seismic data acquisition modules 700A, 700B that are similar to the embodiments 100, 300, 500 described above and illustrated in FIGS. 1 through 6. The acquisition unit 700A illustrated in FIG. 7A, like the acquisition unit 500 illustrated in FIG. 5, includes a telemetry module 770, a power supply module 760, a data collection module 710, and a sensor module 750 joined together in a vertical stack. The acquisition unit 700B illustrated in FIG. 7B is identical to the acquisition unit 700A illustrated in FIG. 7A, except that the position within the vertical stack of the power supply modules 760 and the data collection modules 710 have been switched. Specifically, in FIG. 7A, the power supply module 760 is positioned above the data collection module 710, whereas in FIG. 7B, the data collection module 710 is positioned above the power supply module 760.

In general, and referring still to FIGS. 7A and 7B, the various modules 710, 750, 760, 770 may be releasably coupled together in any arrangement in some embodiments. In some examples, the sensor module 750 is typically positioned proximate the bottom of a vertical stack in order to provide good ground coupling, and the telemetry module 710 is positioned proximate the top of the vertical stack so that any antennas or wires are readily accessible at the surface should the acquisition unit be buried. In other embodiments, however, the sensor module 750 may not be positioned at the bottom of the vertical stack and/or the telemetry 770 module may not be positioned at the top of the vertical stack. For example, with reference back to FIG. 2C, if an external sensor 254 is used, the sensor module may be positioned near the top of a vertical stack. In general, the configurable nature of the modules 710, 750, 760, 770 may allow for any suitable order to be applied, including in non-vertical stacks and other arrangements of the modules 710, 750, 760, 770. The interchangeability within an arrangement of the modules 710, 750, 760, 770 provides flexibility to configure the acquisition unit 700A, 700B as needed for a seismic survey. As just one example, the acquisition unit 700A illustrated in FIG. 7A may be used for a buried application, whereas the acquisition unit 700B illustrated in FIG. 7B may be used for a surface deployment application. In FIG. 7A, having the power supply module 760 (which is typically relatively heavy) higher up in the stack may provide for better coupling of the sensor module 750 with the ground. In FIG. 7B, on the other hand, having the power supply module 760 lower in the stack may cause the acquisition unit 700B to be less top-heavy and less prone to tipping over.

In some embodiments, identifiers (e.g., RFID tags) may be present within each module 710, 750, 760, 770 so that the modules within a given acquisition unit 770A, 770B can be identified and located. Still further, the position of a given module within a given acquisition unit 710, 750, 760, 770 may further be detectable when the acquisition unit 770A, 770B is assembled.

While some embodiments provide flexibility for the order of the modules 710, 750, 760, 770 within a stack or other arrangement, in other embodiments, a certain order may be enforced via one or more connectors between the respective housings of the modules 710, 750, 760, 770. For example, the bottom side of a telemetry module 770 may only mate with the top side of a power supply module 760, and the bottom side of the power supply module 760 may only mate with a data collection module 710, and so forth. In these embodiments, while different modules may still be used, the acquisition units 700 may be designed so as to force a specific order within a vertical stack or other arrangement.

In any event, the modularity and configurability of the modules 710, 750, 760, 770 allows for a wide variety of configurations (not limited to those shown and described herein) of data acquisition units 700A, 700B. The acquisition units 700A, 700B may thus be custom tailored for a specific survey (e.g., a specific seismic survey), and then changed for a subsequent survey. Such customability provides flexibility traditionally associated with acquisition units with interconnecting cables, except without the need for cables and exposed connectors that are prone to failure.

As described below with reference to FIG. 11, one or more of the modules 710, 750, 760, 770 may interchangeably receive (e.g., through one or more connectors of a respective housing) any of a plurality of different modules of a single type and/or may interchangeably receive any of a plurality of different types of modules 710, 750, 760, 770. Each module may be releasably coupled to at least one other module in an abutting relationship in some examples.

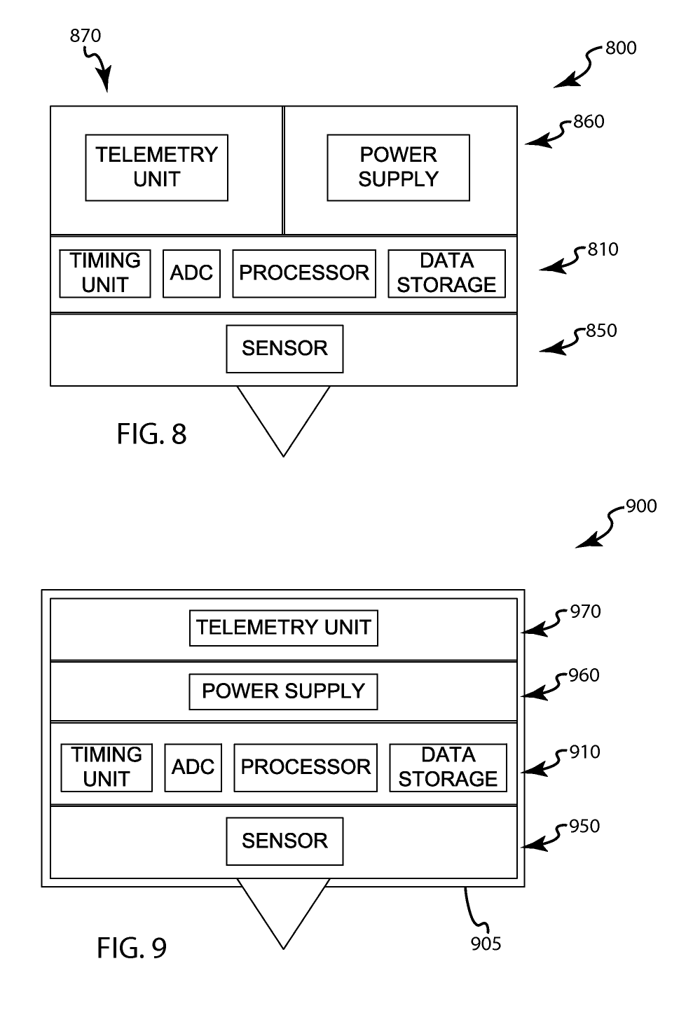

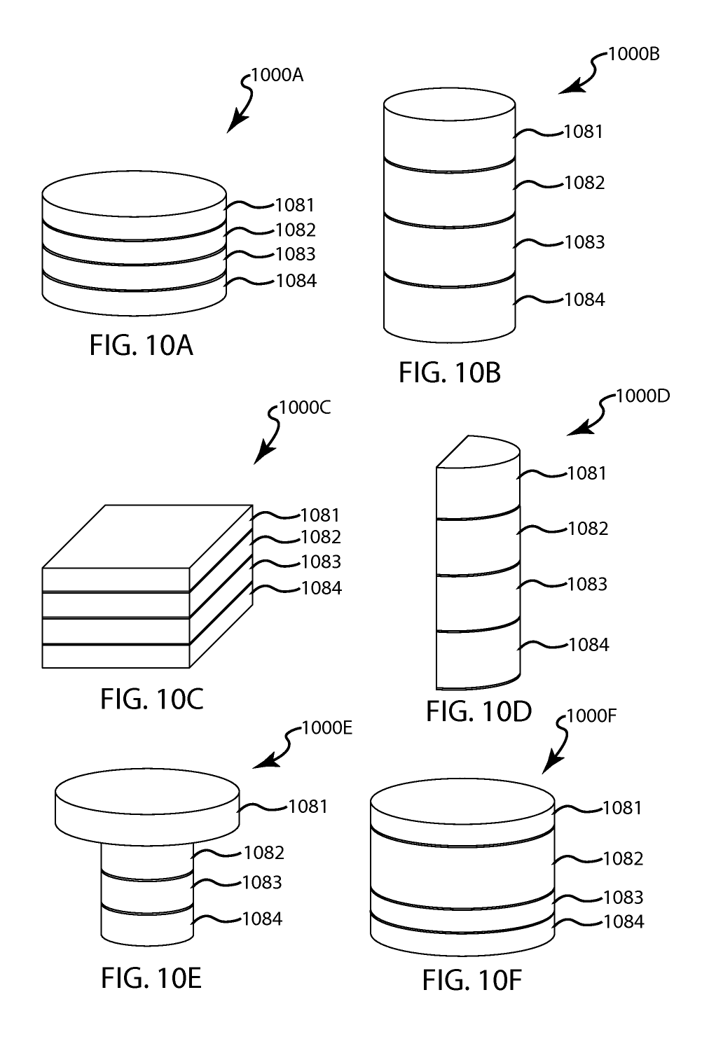

Referring now to FIG. 8, yet another embodiment of a data acquisition unit 800 is illustrated. The acquisition unit 800 illustrated in FIG. 8 is similar to the acquisition unit 500 illustrated in FIG. 5, except that some of the modules 860, 870 are not arranged in a vertical stack. Specifically, in FIG. 8, the acquisition unit 800 includes a sensor module 850 and a data collection module 810 coupled together in a partial vertical stack, and also includes a power supply module 860 and a telemetry module 870 coupled on top of the partial vertical stack. As just one example, the sensor module 850 and the data collection module 810 may have housings that define a generally cylindrical shape and have a substantially similar diameter. The power supply module 860 and the telemetry module 870 may have housings that define generally half-cylindrical shapes and have a substantially similar size, with the two half cylinder shapes of the power supply module and the telemetry module 870 together forming a cylindrical shape with substantially the same diameter as the sensor module 850 and the data collection module 810. As described below with reference to FIG. 10, many different shapes and sizes are possible for the acquisition unit 800, but, as illustrated in FIG. 8, the various modules 810, 850, 860, 870 need not necessarily be arranged in a vertical stack defining a common axis.

FIG. 9 is another embodiment of a data acquisition unit 900. The acquisition unit 900 illustrated in FIG. 9 is also similar to the acquisition unit 500 illustrated in FIG. 5, except that an outer skin 906 is positioned around the housings 910, 950, 960, 970 to at least partially (and in some embodiments fully) enclose the module housings and provide a seal therearound. The outer skin 906 may be flexible and/or waterproof. In some embodiments, the outer skin 906 may be breathable so that air can pass through the outer skin 906 (e.g., so the electronics within the acquisition unit 900 don't overheat), but in some cases the outer skin 906 may prevent dirt, water, or other contaminates from entering into the interior of the outer skin 906. The outer skin 906 may be made of, for example, plastic, elastane, nylon, and so forth. The outer skin 906 may be used when the acquisition unit 900 is buried in the subsurface and/or when it is used in an underwater deployment.

As briefly mentioned above, and with reference now to FIGS. 10A through 10E, the housings 1081, 1082, 1083, 1084 that at least partially define the plurality of modules (e.g., the data collection module, the sensor module, the telemetry module, the power supply module, etc.) may have any one of a number of different suitable shapes. For example, with reference to the acquisition unit 1000A illustrated in FIG. 10A, the housings 1081, 1082, 1083, 1084 may have a cylindrical shape, with a relatively low profile such that they each form a disk shape. In another example, and as illustrated by the acquisition unit 1000B in FIG. 10B, the housings 1081, 1082, 1083, 1084 may have a cylindrical shape, but may be relatively tall and thus define a generally elongated cylindrical acquisition unit 1000B as compared with the overall disk-shaped acquisition unit 1000A illustrated in FIG. 10A. The housings 1081, 1082, 1083, 1084 however, need not be circular, as illustrated by the acquisition unit 1000C in FIG. 10C wherein the housings 1081, 1082, 1083, 1084 are cubed and define a square cross section. As still another potential shape, the housings 1081, 1082, 1083, 1084, may define an extruded D-shape (e.g., a cylindrical shape with a portion cut off on one side), as shown by the acquisition unit 1000D illustrated in FIG. 10D. The housings 1081, 1082, 1083, 1084 may alternatively define still other shapes, such as a hexagon, an octagon, and so forth, and need not all define the same shape (e.g., some may be circular while others are hexagonal).

With reference to FIG. 10E, the housings 1081, 1082, 1083, 1084 need not have the same diameter, cross-sectional shape, or area. For example, in one example of an acquisition unit, a top housing 1081 (which may be, e.g., a telemetry module) may have a much larger diameter than the other housings 1082, 1083, 1084. In other examples (not shown), a bottom housing 1084 may have a greater diameter, or a middle housing 1083, 1082 may have a greater diameter than the other modules within the stack. Furthermore, as discussed above with reference to FIG. 8, the housings 1081, 1082, 1083, 1084 need not necessarily define a common axis—although in some embodiments as illustrated in FIGS. 10A through 10F, the housings 1081, 1082, 1083, 1084 are arranged in a vertical stack defining a common vertical axis through the centers of each of the housings 1081, 1082, 1083, 1084.

With reference to FIG. 10F, the housings 1081, 1082, 1083, 1084 need not necessarily have the same thickness or height. For example, a middle housing 1082 may be much thicker or taller than the other housings 1081, 1083, 1084 in some examples because the middle housing 1082 may enclose a high capacity battery for example. In other examples, others of the housings 1081, 1082, 1083, 1084 may be smaller or larger than the other housings 1081, 1082, 1083, 1084.

Referring now to FIGS. 11A through 11C, each module of an acquisition unit may include one or more connectors which, as described below, may be integral with the respective housing for the module, attached to the respective housing, and so forth. In the acquisition unit 100 illustrated in FIG. 1, for example, each of the first and second housings 111, 151 associated with the first and second modules 110, 150 may include a respective connector (not shown in FIG. 1, but several examples are shown in FIGS. 11A through 11C and described below): the first housing 111 may include a first connector, and the second housing 151 may include a second connector.

Each connector may releasably couple to another connector or to a different portion of the housing of another module. For example, some embodiments of connectors may allow one module to be interchangeably coupled to another module and/or to a plurality of different types of modules. With reference back to FIG. 1, a connector of the first housing 111 may interchangeably couple the data collection module 110 to a plurality of varying types of modules (e.g., sensor modules 150, 250A, 250B, 250C, 250D). In some examples, the connector may cause an outer surface of the housing 111 of the data collection module 110 to abut an outer surface of the other module to which it is coupled. The connector may provide mechanical and/or electrical coupling between one or more modules in some embodiments. In some examples, the connector(s) may have a relatively low profile and/or may provide a resistive force that must be overcome to disconnect the modules. In some embodiments, the connector allows for a quick-connect and quick-disconnect, which may be accomplished by a user without any tools such as a screwdriver or drill.

Some modules may include a connector on one or more sides. For example, the housing 511 of the data collection module 510 of the acquisition unit 500 illustrated in FIG. 5 may include a first connector that releasably couples the first housing 511 to a second housing 551 of the sensor module 550, and the first housing 511 may also include a second connector that releasably couples the first housing 511 to a third housing 561 of the power supply module 560. The first connector may be located on the bottom side of the housing 511, and the second connector may be located on the top side of the housing 511 in some examples. In general, each module or its associated housing may include one or more connectors. The connectors may be male and/or female type connectors. In some examples, a combination of male and female connectors may be used to force a certain arrangement or coupling of the modules.

In some examples, a connector may be integral with and defined by its respective housing. For example, the connector may be made of the same material and may be molded, or otherwise integrally formed, together with the housing. In other examples, the connector may be made of a different material and/or may be separate from but securely attached to the housing. As just one example, a female-type connector may be integral with and made from the same material as its respective housing, whereas a male connector may be made from a different material and screwed onto, or otherwise attached to, its respective housing.

Referring now to FIGS. 11A through 11C several non-limiting examples of connectors will be described in the context of first and second housings 1111, 1121 of first and second modules 1110, 1120. In FIG. 11A, the first housing 1111 may define a recess 1132 into which a protrusion 1134 of the second housing 1121 may be received. The recess 1132 may be at least a part of the connector for the first housing 1111, and the protrusion 1134 may be at least a part of the connector for the second housing 1121. The recess 1132 and the protrusion 1134 may each define one or more threads, and the threads of the protrusion 1134 may engage the threads of the recess 1132 when the first and second housings 1111, 1121 are attached together. In some embodiments, the protrusion 1134 may have a slightly larger diameter than the opening of the recess 1132, but the protrusion may be slightly resilient and thus form a snug tight fit in the recess 1132 when the first and second housings are coupled together.

In FIG. 11B, both the first and second housings 1111, 1121 define respective protrusions 1133, 1134 and the first and second housings 1111, 1121 may also define respective recesses 1132, 1135. The protrusion 1134 of the second housing 1121 may be releasably received in the recess 1132 of the first housing 1111, and the protrusion 1133 of the first housing 1111 may be releasably received in the recess 1135 of the second housing 1121, when the two housings 1111,1121 are coupled together. The protrusions 1133, 1134 and recesses 1132, 1135 may be configured in a bayonet connector style, whereby each protrusion 1133, 1134 defines a locking pick that is rotatably received in a slot of the recesses 1132, 1135.

With reference to FIG. 11C, a connector may include a connector member 1138 in some examples. The connector member 1138 may, for example, be a cylindrical body with threads along the circular perimeter. The threads of the connector member 1138 may engage corresponding threads formed on walls of each housing 1111, 1121 that define respective recesses in each housing that receives a portion of the connector member 1138 such that the connector (rotatably) secures the first and second housings 1111, 1121 together. The connector member 1138 may be metal in some examples, whereas the first and second housings 1111, 1121 may be plastic. Also, in some examples, an o-ring or other type of seal 1139 may be used to prevent contamination of the acquisition unit through, for example the mating threads of the connector member 1138 and the first and second housings 1111, 1121. The seal 1139 may be radial and extend around a circular perimeter between the two housings 1111, 1121 and/or around a circular perimeter of the connector member 1138. By securing the first and second housings 1111, 1121 together via the connector member 1138, outer surfaces of the first and second housings may engage the o-ring seal 1139 positioned therebetween in order to seal the interior of the acquisition unit. Of course, many different seals may be used, and those seals, including the seal 1139 shown in FIG. 11C, may be used regardless of the type of connector used between housings of modules.

In some embodiments, a connector may include one or more biasing members adapted to release the housing of one module from the housing of another module only on the application of a positive release force. Referring to FIGS. 11D through 11H, in one embodiment, a surface of a module housing may include two L-shaped recesses 1132, 1135, and a surface of another module housing may include two arm protrusions 1133, 1134. One or more springs or other biasing devices 1143 may bias the two module housings apart when they are coupled together such that a seal (e.g., an o-ring) 1139 on the arm protrusions 1133, 1134 engages an interior surface of the recesses 1132, 1135. When a force is exerted to overcome the ‘push’ of the biasing member, the arm protrusions 1133, 1134 can move freely within the L-shaped recesses 1132, 1135. To couple the two module housings together, the arm protrusions 1133, 1134 may be inserted in the L-shaped recesses 1132, 1135, and rotated past a narrow (in depth) portion until it expands in an inner chamber of the L-shaped recess (as shown in FIG. 11E) where the depth expands again allowing the biasing members 1139 to bias the two housings apart from each other. To uncouple the two module housings, the housings are forced together to overcome the force exerted by the biasing members 1139, and the housings are rotated relative to one another until the arm protrusions 1133, 1134 clear the narrow portion of the L-shaped recesses 1132, 1134.

As mentioned above, in some embodiments the connector(s) between two housings may provide electrical communication between two different modules. For example, a connector may include electrical interconnects between the different modules. The electrical interconnect may be, as just one example, raised, spring-loaded electrical contact balls on both modules. In another embodiment, a spring-loaded electrical contact may be included on one housing/module and a non-spring-loaded electrical contact provided on the other housing/module. The connection for electrical communication may be together with the mechanical coupling provided by the connector in some embodiments, whereas in other embodiments, the connector includes separate mechanical and electrical coupling elements (e.g., the threaded connector member 1138 described above as the mechanical coupler and the spring-loaded electrical contact balls as the electrical coupler). Also, the electrical coupling among the modules may include power and/or data. For example, power may be provided to one or more of the modules in an acquisition unit through a common power bus in some examples, and data may be provided among one or more of the modules through a common data bus. In some examples, data and power are only provided to all modules (e.g., a common bus), whereas in other examples, data and power are electrically coupled to different modules in different ways (if at all). For example, referring to FIG. 5, the electrical connector may provide power from the power supply modules 560 and/or from the data collection module 510 to one or more of the other modules 510, 550, 560, 570. A one-way data line may be provided from the sensor module 550 to the data collection module 510, a two-way data line may be provided between the telemetry module 570 and the data collection module 510, but in some examples, no data lines may couple the telemetry module 570 with the sensor module 550.

As still another example, electrical power may be provided through one or more connectors between the modules, but all data may be exchanged between the modules using high-bandwidth, low range wireless signals (e.g., WiFi) so that no data lines are needed in the acquisition unit.

Although FIGS. 11A through 11C and the corresponding description have given several examples of connectors between different modules in a configurable acquisition unit, many other may also or alternatively be used, including a bayonet connector, a screw connector, a push button connector, a quick connect connector, a cam lock connector, an axial connector, a sliding connector, an arcuately aligned connector, a locking collar with a quarter turn connector, and so forth. Also, in some examples, a light (e.g., LED) or other indicator may display an indication of a good electrical or mechanical lock or contact as a result of the one or more connectors.

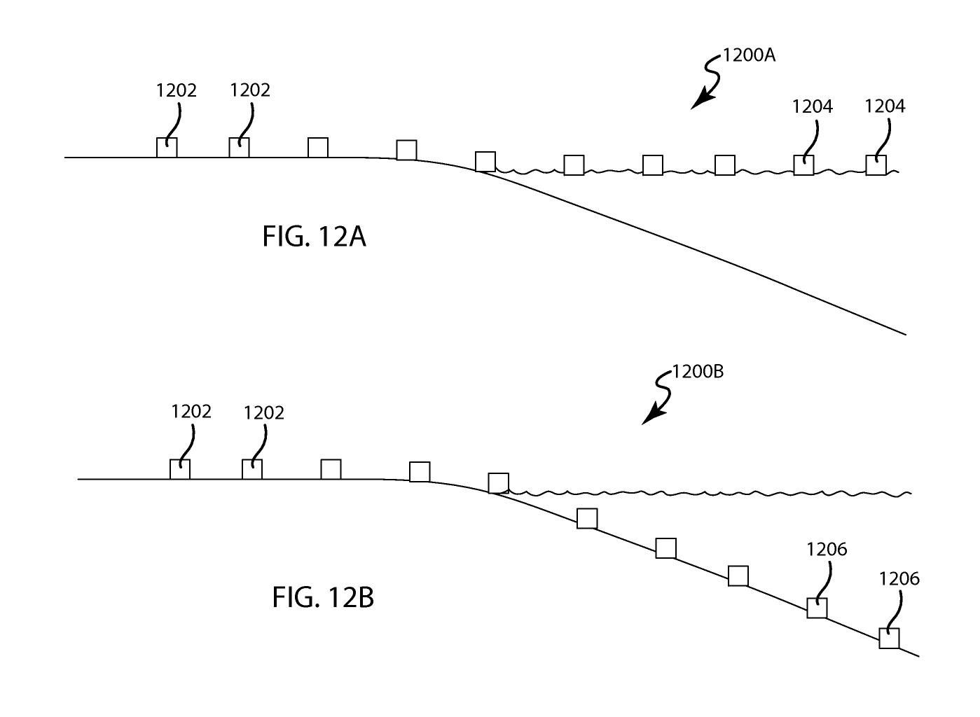

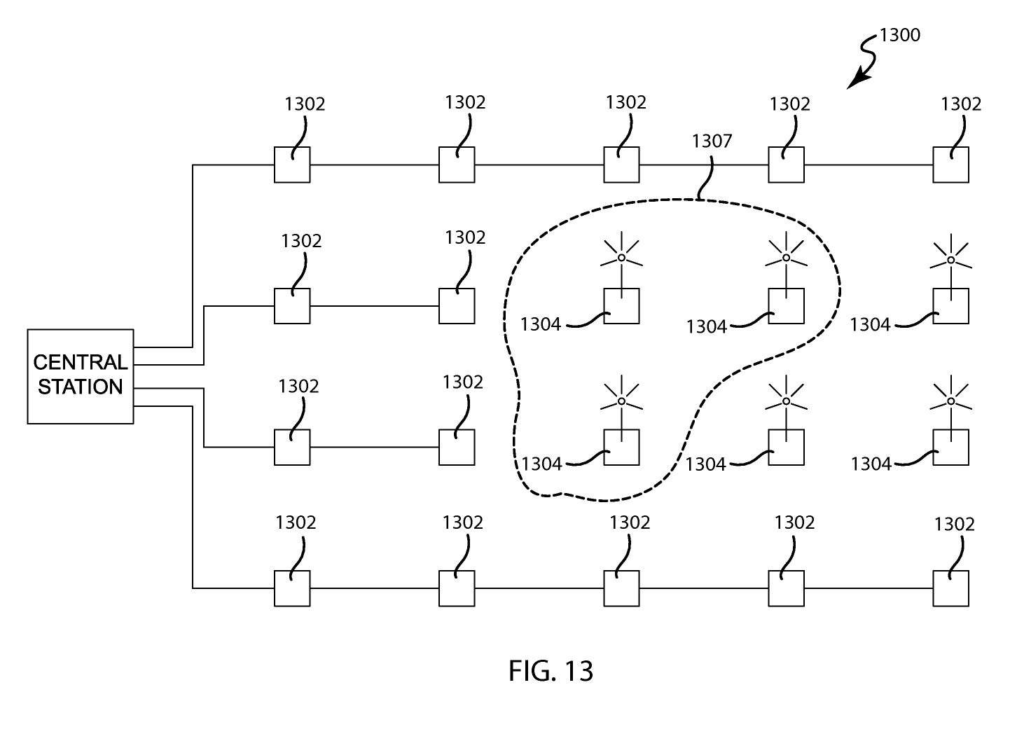

With reference now to FIGS. 12A, 12B, and 13, several examples are given of possible implementations using the acquisition units 100, 300, 500, 700A, 700B, 800, 900, 1000A, 1000B, 1000C, 1000D described above. The examples given in FIGS. 12A, 12B, and 13 may be referred to as “mixed-mode” because they allow for similar components to be used in different topographies, thereby allowing greater accessibility in a seismic survey and increased utility for the configurable acquisition units described herein. The data acquired using similar components (e.g., a common data collection module 110), even if used in different topographies with different attachment modules, may be desirable in some examples because the data may be comparable or similar. In previous approaches, in contrast, data acquired using two different sets of equipment in two different topographies sometimes needed to be filtered and calibrated against each other before being merged. Using similar components in acquisition units, as taught herein, may avoid the need to filter or calibrate the data acquired in two different topographies in some embodiments.

Of course, the acquisition units described above may be used in any implementation, including standard, single-mode, land or marine based seismic surveys, and are not limited to use in the implementations described here.

FIG. 12A illustrates a potential transition zone application 1200A with two pluralities of configurable data acquisition units 1202, 1204. The acquisition units 1202, 1204 may be any of those described above. The acquisition units 1202 in the first plurality may be configured for a first topography, and the acquisition units 1204 in the second plurality may be configured for a second topography. For example, the first topography may be land, and the second topography may be floating on the surface of a body of water with a relatively shallow depth (e.g., 0 to 20 meters). Other examples of topography, as explained below with reference to FIG. 12B include, for example, the water bottom.

At least some of the acquisition units 1202 from the first plurality may include a substantially similar data collection module (e.g., 110, 310, 510, 710, etc. above) as at least some of the acquisition units 1204 from the second plurality. In some examples, all of the acquisition units 1202, 1204 may have identical data collection modules, which may be defined by a housing and may be configured to be releasably coupled to and uncoupled from at least one other module through one or more connectors, as described above.

Referring back to FIG. 12A, the acquisition units 1204 in the second plurality may include a buoy for floatation so that they float on the surface of the water. The buoy may be included within or around one or several modules of the acquisition units 1204. The acquisition units 1204 may be water-tight, and may include a hydrophone within or external to their respective sensor modules. For example, a hydrophone may be coupled to an external connector of the sensor module and may hang down in the water. In some examples, an external hydrophone may be coupled to the sensor module, and the sensor module may internally house one or more motion sensors. In still other examples, a hydrophone may be positioned internal to the sensor module, and/or a motion sensor may be positioned external to the sensor module. In general, and referring back to FIGS. 2A through 2C, any suitable sensor module with any suitable sensor(s) may be used in the acquisition units 1202. In some examples, the acquisitions units 1204 may be tethered or otherwise anchored to prevent them from drifting beyond a certain range of tolerance. Also, the acquisition units 1204 may, in some embodiments, include a GPS or other positioning/timing system in order to obtain position and/or timing information without the need for an expensive internal clock or locator.

Still referring to FIG. 12A, the acquisition units 1202 in the first plurality may be similar to those units 1204 in the second plurality, except the acquisition units 1202 in the first plurality may be adapted to be buried in the subsurface, and may thus include, for example, one or more motion sensors, such as a 1C/3C geophone or accelerometer. The data collection module, however, may be identical or substantially similar among the two pluralities in some embodiments, however, as may be one or more other modules. In other examples, the data collection module may be different amongst the two pluralities, but a power supply module may be common to the two pluralities.

Referring now to the application 1200B illustrated in FIG. 12B, the acquisition units 1206 in the second plurality may be deployed on the water bottom, rather than floating on the surface of the water. In this manner, the acquisition units 1202, 1206 in both the first and second pluralities may include identical motion sensors extending from on shore through to the transition zone. The acquisition units 1206 may include some weight so that they sink to the water bottom, and may be water-tight in some examples. The acquisition units 1206 may include motion and/or pressure sensors, and may or may not include an internal clock. In one example, the acquisition units 1206 may include a very accurate internal clock in order to accurately record seismic data. In other examples, the acquisition units 1206 may include a clock with a well characterized drift rate, and may record seismic data using the drifting clock and then subsequently correct for the drift using, for example, recorded temperature data and/or interpolation between a start and end point as measured by a device or as measured against a known clock (e.g., GPS). In still other examples, the acquisition units 1206 may be cabled and may thus receive timing data from a central station through one or more cables.

Similar to FIGS. 12A and 12B, FIG. 13 is an illustration of yet another mixed-mode implementation 1300 using two pluralities of configurable acquisition units 1302, 1304. In FIG. 13, a portion of the seismic survey area may not be adapted for cable-based seismic acquisition due to a disturbance 1307. It may be desirable in some instances to use cabled acquisition units 1302 whenever possible, but the disturbance 1307 may make it difficult or impossible for the entire survey to be done using cabled acquisition units. Thus, in those areas, wireless acquisition units 1304 (illustrated with an antenna in FIG. 13) may be used in areas that are otherwise not adapted for access required by cabled acquisition units. Similar to the implementations discussed with reference to FIGS. 12A and 12B, the commonality of one or more components between the acquisition units 1302, 1304 in the first and second pluralities (e.g., they may be identical except one has a cabled telemetry module and the other has a wireless telemetry module) may provide similar and comparable data that can be merged relatively easily to generate consistent seismic data for the entire survey area, the disturbance 1307 notwithstanding.

The disturbance 1307 may be, for example, a street, or urban area, or it may also be a body of water, or some other blockage. Referring now to FIGS. 12A, 12B, and 13, in some embodiments, cabled acquisition units 1302 may be used onshore, with wireless acquisition units 1304 used off shore, whereas in other embodiments, wireless acquisition units 1304 may be used onshore, with cabled acquisition 1302 units used off shore.

The apparatuses and associated methods in accordance with the present disclosure have been described with reference to particular embodiments thereof in order to illustrate the principles of operation. The above description is thus by way of illustration and not by way of limitation. Various modifications and alterations to the described embodiments will be apparent to those skilled in the art in view of the teachings herein. Those skilled in the art may, for example, be able to devise numerous systems, arrangements and methods which, although not explicitly shown or described herein, embody the principles described and are thus within the spirit and scope of this disclosure. Accordingly, it is intended that all such alterations, variations, and modifications of the disclosed embodiments are within the scope of this disclosure.

For example, although FIGS. 1, 3, and 5 illustrate various arrangements of different components in different modules, in general, any component may be positioned in any module. For example, although FIG. 1 illustrates a sensor 152 being included with the sensor module 150 and the other components 120, 122, 124, 126, 162, 172 being included with the data collection module 110, in other embodiments, the components may be arranged differently. For example, in one embodiment (not shown in the figures) a sensor may be included in a first module along with a processor, a data storage, a power supply, an analog to digital converter, and a timing unit, and a telemetry module may be releasably coupled to that first module. In this manner, the telemetry module may be quickly interchangeable with different telemetry modules. As another example, the power supply and the data storage may both be included with one module, in order to remove both the power supply (for recharging) and the data storage (for data downloading) at the same time. In general, any suitable arrangement of components within any number of modules may be used.

Where appropriate, common reference words are used for common structural and method features. However, unique reference words are sometimes used for similar or the same structural or method elements for descriptive purposes. As such, the use of common or different reference words for similar or the same structural or method elements is not intended to imply a similarity or difference beyond that described herein.

In methodologies directly or indirectly set forth herein, various steps and operations are described in one possible order of operation, but those skilled in the art will recognize that the steps and operations may be rearranged, replaced, or eliminated without necessarily departing from the spirit and scope of the disclosed embodiments.

All relative and directional references (including: upper, lower, upward, downward, left, right, leftward, rightward, top, bottom, side, above, below, front, middle, back, vertical, horizontal, and so forth) are given by way of example to aid the reader's understanding of the particular embodiments described herein. They should not be read to be requirements or limitations, particularly as to the position, orientation, or use of the invention unless specifically set forth in the claims. Connection references (e.g., attached, coupled, connected, joined, and the like) are to be construed broadly and may include intermediate members between a connection of elements and relative movement between elements. As such, connection references do not necessarily infer that two elements are directly connected and in fixed relation to each other, unless specifically set forth in the claims.

What is claimed is:

1. An acquisition unit, comprising:
a seismic data collection module including a first housing;
a second module including a second housing;
the first housing is releasably coupled to the second housing; and
when the first housing is coupled to the second housing, an outer surface of the first housing abuts an outer surface of the second housing.

2. The acquisition unit of claim 1, wherein the first housing includes a first connector and the second housing includes a second connector, and one of the first or second connectors releasably receives the other of the first or second connectors.

3. The acquisition unit of claim 2, wherein the first connector releasably receives at least one protrusion from the second connector, and the second connector releasably receives at least one protrusion from the first connector.

4. The acquisition unit of claim 2, wherein the outer surface of the first housing abuts the outer surface of the second housing around an entire perimeter of one or both of the first and second connectors.

5. The acquisition unit of claim 1, wherein a recess defined in one of the first or second housings releasably receives a protrusion from the other of the first or second housings.

6. The acquisition unit of claim 1, wherein a connector of the first housing interchangeably receives a complementary connector of any of a plurality of different types of modules in addition to the second module.

7. The acquisition unit of claim 1, wherein the first housing defines the first module, the second housing defines the second module, and the second housing is separate and distinct from the first housing.

8. The acquisition unit of claim 1, wherein the second module comprises a sensor module.

9. The acquisition unit of claim 8, wherein the sensor module comprises a terminal for connection to an external sensor.

10. The acquisition unit of claim 1, wherein the second module comprises a power supply module.

11. The acquisition unit of claim 10, wherein the power supply module comprises a terminal for connection to an external power source.

12. The acquisition unit of claim 1, wherein the second module comprises a telemetry module.

13. The acquisition unit of claim 12, wherein the telemetry module is one of a wireless communications unit, a wired communications unit, or an autonomous node communications unit.

14. The acquisition unit of claim 1, wherein the seismic data collection module comprises a telemetry unit, and the second module comprises a sensor module.

15. The acquisition unit of claim 1, wherein a first connector attached to or defined by the first housing comprises a biasing member adapted to release the second housing from the first housing only on the application of a release force.

16. A seismic acquisition unit, comprising:
a first housing at least partially enclosing a data storage;
a second housing at least partially enclosing a seismic sensor; and
a third housing at least partially enclosing one of a power supply unit or a telemetry unit;
wherein each of the first, second, and third housings includes a coupling connector configured to releasably couple the respective housing to one of the other of the first, second, or third housings.

17. The seismic acquisition unit of claim 16, wherein the coupling connector of each of the first, second, and third housings is configured to releasably couple the respective housing to one of the other of the first, second, and third housings in an abutting relationship.

18. The seismic acquisition unit of claim 16, wherein the coupling connector of the first housing is a first coupling connector that releasably couples the first housing to the second housing, and the first housing further includes a second coupling connector configured to releasably couple the first housing to the third housing.

19. The acquisition unit of claim 16, further comprising a fourth housing at least partially enclosing a fourth module, the fourth housing also including a connector configured to releasably couple with one of the first, second, or third housings.

20. A seismic data collection apparatus, comprising:
a seismic data collection module including a first housing; and
the first housing including a connector adapted to interchangeably couple the seismic data collection module to a plurality of varying types of modules such that an outer surface of the respective varying types of modules abuts an outer surface of the first housing.

21. The apparatus of claim 20, wherein the connector interchangeably secures the seismic data collection module to one of the plurality of varying types of modules such that a positive force is needed to release the seismic data collection module from the one of the plurality of varying types of modules.

22. The apparatus of claim 21, wherein the connector rotatably secures the seismic data collection module to the one of the plurality of varying types of modules.

23. A mixed-mode seismic surveying system, comprising:
a first plurality of acquisition units configured for a first topography; and
a second plurality of acquisition units configured for a second topography;
wherein each of the acquisition units in the first and second pluralities of acquisition units includes a substantially similar data collection module defined by a first housing and configured to be releasably coupled to and uncoupled from at least one other module via a first connector of the first housing.

24. The apparatus of claim 23, wherein the first connector of the first housing for each of the respective data collection modules causes an outer surface of the first housing to abut an outer surface of a second housing of the at least one other module when the data collection module is coupled to the at least one other module.

25. The system of claim 23, wherein the first topography is a transition zone, and each of the first plurality of acquisition units comprises a buoy for floatation.

26. The system of claim 25, wherein the second topography is a land zone proximate the transition zone, and each of the second plurality of acquisition units comprises a sensor module adapted to be buried in the subsurface.

27. The system of claim 23, wherein the first topography is adapted for cable-based seismic acquisition and the second topography is not adapted for cable-based seismic acquisition, and further wherein each of the first plurality of acquisition units comprises a cabled telemetry unit configured to receive a cable coupled to and in communication with a central station and each of the second plurality of acquisition units comprises a wireless telemetry unit configured to wirelessly communicate with the central station.

28. The system of claim 23, wherein one of the first or second topographies is underwater.
